(19) United States
(12) Patent Application Publication
(10) Pub. No.: US 2025/0386347 A1
(43) Pub. Date: Dec. 18, 2025

(54) METHODS AND APPARATUSES FOR UPLINK TRANSMISSION IN A FULL DUPLEX SYSTEM

(71) Applicant: Lenovo (Beijing) Limited, Beijing (CN)

(72) Inventors: Yuantao Zhang, Beijing (CN); Ruixiang Ma, Beijing (CN); Hongmei Liu, Beijing (CN); Zhi Yan, Beijing (CN); Haiming Wang, Beijing (CN)

(73) Assignee: Lenovo (Beijing) Limited, Beijing (CN)

(21) Appl. No.: 18/877,497

(22) PCT Filed: Jun. 24, 2022
(86) PCT No.: PCT/CN2022/101143

§ 371 Date: Dec. 20, 2024

(51) Int. Cl. H04W 72/21; H04W 72/232

(52) U.S. Cl. CPC H04W 72/21; H04W 72/232

(57) ABSTRACT

Embodiments of the present disclosure relate to methods and apparatuses for uplink (UL) transmission in a full duplex (FD) system. According to some embodiments of the disclosure, a user equipment (UE) may include: a transceiver configured to receive configurations of one or more rate match patterns; and a processor coupled to the transceiver and configured to determine whether physical resources in an uplink (UL) subband are available or not for a physical uplink shared channel (PUSCH) transmission based on the one or more rate match patterns.

### TECHNICAL FIELD

Embodiments of the present disclosure generally relate to wireless communication technology, and more particularly to methods and apparatuses for uplink (UL) transmission in a full duplex (FD) system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time. Details regarding UL transmission in a full duplex system need to be studied.

### SUMMARY

Some embodiments of the present disclosure provide a user equipment (UE). The UE may include: a transceiver configured to receive configurations of one or more rate match patterns; and a processor coupled to the transceiver and configured to determine whether physical resources in a UL subband are available or not for a physical uplink shared channel (PUSCH) transmission based on the one or more rate match patterns.

In some embodiments of the present disclosure, the one or more rate match patterns are configured for a PDSCH transmission, and determining whether physical resources in the UL subband are available or not for the PUSCH transmission comprises: in the case that resources allocated for the PUSCH transmission in the UL subband include reserved resources configured by a rate match pattern in the one or more rate match patterns, determining that a whole symbol(s) (e.g., OFDM symbol(s)) including the reserved resources in the resources allocated for the PUSCH transmission is not available for the PUSCH transmission.

In some embodiments of the present disclosure, the one or more rate match patterns are configured for a physical downlink shared channel (PDSCH) transmission, and determining whether physical resources in the UL subband are available or not for the PUSCH transmission comprises: in the case that resources allocated for the PUSCH transmission in the UL subband include reserved resources configured by a rate match pattern in the one or more rate match patterns and the rate match pattern is within a rate match pattern group, determining that the reserved resources are available for the PUSCH transmission.

In some embodiments of the present disclosure, the one or more rate match patterns are configured for a PDSCH transmission, and the processor is further configured to determine at least one rate match pattern applicable for the PUSCH transmission based on the one or more rate match patterns.

In some embodiments of the present disclosure, determining the at least one rate match pattern applicable for the PUSCH transmission based on the one or more rate match patterns comprises, in the case that reserved resources configured by a rate match pattern in the one or more rate match patterns are fully or partly within resources allocated for the PUSCH transmission in the UL subband, determining that the rate match pattern in the one or more rate match patterns is a rate match pattern applicable for the PUSCH transmission.

In some embodiments of the present disclosure, determining whether physical resources in the UL subband are available or not for the PUSCH transmission comprises, in the case that a symbol in resources allocated for the PUSCH transmission in the UL subband includes reserved resources configured by an activated rate match pattern(s) applicable for the PUSCH transmission, determining a frequency domain region out of the reserved resources in the symbol that includes a maximum number of consecutive resource units is available for the PUSCH transmission; or determining that the symbol is not available for the PUSCH transmission.

In some embodiments of the present disclosure, the transceiver is further configured to receive configurations of one or more rate match pattern groups for PDSCH transmission, and the processor is further configured to: determine that a rate match pattern group in the one or more rate match pattern groups is applicable for the PUSCH transmission in the case that reserved resources configured by a rate match pattern in the rate match pattern group are fully or partly within resources allocated for the PUSCH transmission in the UL subband.

In some embodiments of the present disclosure, the transceiver is further configured to receive downlink control information (DCI) scheduling the PUSCH transmission, and the DCI indicates whether a rate match pattern group applicable for the PUSCH transmission is activated or deactivated.

In some embodiments of the present disclosure, the one or more rate match patterns are configured for the PUSCH transmission.

In some embodiments of the present disclosure, a configuration of a rate match pattern includes at least one bitmap indicating reserved resources, and the at least one bitmap is configured based on at least one of: a configuration for the UL subband; or a slot including the UL subband.

In some embodiments of the present disclosure, a configuration of a rate match pattern includes an identity (ID) of a control resource set (CORESET) including reserved resources and an ID of a bandwidth part (BWP) associated with the CORESET.

In some embodiments of the present disclosure, a rate match pattern for PUSCH transmission is associated with a corresponding rate match pattern for a PDSCH transmission, and a rate match pattern of the one or more rate match patterns includes reserved resources configured by the corresponding rate match pattern for the PDSCH transmission and is within the UL subband.

In some embodiments of the present disclosure, the transceiver is further configured to receive configurations of one or more rate match pattern groups for the PUSCH transmission.

In some embodiments of the present disclosure, the transceiver is further configured to receive DCI scheduling the PUSCH transmission, and the DCI indicates whether the one or more match pattern groups are activated or deactivated.

In some embodiments of the present disclosure, determining whether physical resources in the UL subband are available or not for the PUSCH transmission comprises in the case that a symbol in resources allocated for the PUSCH transmission in the UL subband includes reserved resources configured by an activated rate match pattern(s) in the one or more rate match patterns, determining a frequency domain region out of the reserved resources in the symbol that includes a maximum number of consecutive resource units is available for the PUSCH transmission; or determining that the symbol is not available for the PUSCH transmission.

Some embodiments of the present disclosure provide a base station (BS). The BS may include: a transceiver configured to transmit configurations of one or more rate match patterns; and a processor coupled to the transceiver and configured to determine whether physical resources in a UL subband are available or not for a PUSCH transmission based on the one or more rate match patterns.

In some embodiments of the present disclosure, the one or more rate match patterns are configured for a PDSCH transmission, and determining whether physical resources in the UL subband are available or not for the PUSCH transmission comprises: in the case that resources allocated for the PUSCH transmission in the UL subband include reserved resources configured by a rate match pattern in the one or more rate match patterns, determining that a whole symbol(s) (e.g., OFDM symbol(s)) including the reserved resources in the resources allocated for the PUSCH transmission is not available for the PUSCH transmission.

In some embodiments of the present disclosure, the one or more rate match patterns are configured for a PDSCH transmission, and determining whether physical resources in the UL subband are available or not for the PUSCH transmission comprises: in the case that a rate match pattern in the one or more rate match patterns is within a rate match pattern group: determining that the reserved resources configured by the rate match pattern are available for the PUSCH transmission when the rate match pattern group is deactivated; or determining that the reserved resources configured by the rate match pattern are not available for the PUSCH transmission when the rate match pattern group is activated.

In some embodiments of the present disclosure, the one or more rate match patterns are configured for a PDSCH transmission, and the processor is further configured to determine at least one rate match pattern applicable for the PUSCH transmission based on the one or more rate match patterns.

In some embodiments of the present disclosure, determining the at least one rate match pattern applicable for the PUSCH transmission based on the one or more rate match patterns comprises, in the case that reserved resources configured by a rate match pattern in the one or more rate match patterns are fully or partly within resources allocated for the PUSCH transmission in the UL subband, determining that the rate match pattern in the one or more rate match patterns is a rate match pattern applicable for the PUSCH transmission.

In some embodiments of the present disclosure, determining whether physical resources in the UL subband are available or not for the PUSCH transmission comprises in the case that a symbol in resources allocated for the PUSCH transmission in the UL subband includes reserved resources configured by an activated rate match pattern(s) applicable for the PUSCH transmission, determining a frequency domain region out of the reserved resources in the symbol that includes a maximum number of consecutive resource units is available for the PUSCH transmission; or determining that the symbol is not available for the PUSCH transmission.

In some embodiments of the present disclosure, the transceiver is further configured to transmit configurations of one or more rate match pattern groups for PDSCH transmission, and the processor is further configured to: determine that a rate match pattern group in the one or more rate match pattern groups is applicable for the PUSCH transmission in the case that reserved resources configured by a rate match pattern in the rate match pattern group are fully or partly within resources allocated for the PUSCH transmission in the UL subband.

In some embodiments of the present disclosure, the transceiver is further configured to transmit DCI scheduling the PUSCH transmission, and the DCI indicates whether a rate match pattern group applicable for the PUSCH transmission is activated or deactivated.

In some embodiments of the present disclosure, the one or more rate match patterns are configured for the PUSCH transmission.

In some embodiments of the present disclosure, a configuration of a rate match pattern includes at least one bitmap indicating reserved resources, and the at least one bitmap is configured based on at least one of: a configuration for the UL subband; or a slot including the UL subband.

In some embodiments of the present disclosure, a configuration of a rate match pattern includes an ID of a CORESET including reserved resources and an ID of a BWP associated with the CORESET.

In some embodiments of the present disclosure, a rate match pattern for PUSCH transmission is associated with a corresponding rate match pattern for a PDSCH transmission, and a rate match pattern of the one or more rate match patterns includes reserved resources configured by the corresponding rate match pattern for the PDSCH transmission and is within the UL subband.

In some embodiments of the present disclosure, the transceiver is further configured to receive configurations of one or more rate match pattern groups for the PUSCH transmission.

In some embodiments of the present disclosure, the transceiver is further configured to transmit DCI scheduling the PUSCH transmission, and the DCI indicates whether the one or more match pattern groups are activated or deactivated.

In some embodiments of the present disclosure, determining whether physical resources in the UL subband are available or not for the PUSCH transmission comprises in the case that a symbol in resources allocated for the PUSCH transmission in the UL subband includes reserved resources configured by an activated rate match pattern(s) in the one or more rate match patterns, determining a frequency domain region out of the reserved resources in the symbol that includes a maximum number of consecutive resource units is available for the PUSCH transmission; or determining that the symbol is not available for the PUSCH transmission.

Some embodiments of the present disclosure provide a method performed by a UE. The method may include: receiving configurations of one or more rate match patterns; and determining whether physical resources in a UL subband are available or not for a PUSCH transmission based on the one or more rate match patterns.

Some embodiments of the present disclosure provide a method performed by a BS. The method may include: transmitting configurations of one or more rate match patterns; and determining whether physical resources in a UL subband are available or not for a PUSCH transmission based on the one or more rate match patterns.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system according to some embodiments of the present disclosure;

FIG. 2 illustrates exemplary duplex modes according to some embodiments of the present disclosure;

FIG. 3 illustrates exemplary radio resources in a time division duplex (TDD) system according to some embodiments of the present disclosure;

FIGS. 4(a) and 4(b) illustrate exemplary bitmaps in a configuration of a rate match pattern according to some embodiments of the present disclosure;

FIG. 5 illustrates exemplary CORESETs according to some embodiments of the present disclosure;

FIGS. 6(a) and 6(b) illustrate examples in which the reserved resources for DL transmission are in a UL subband for UL transmission according to some embodiments of the present disclosure;

FIG. 7 is a flow chart illustrating an exemplary method for UL transmission in a full duplex system according to some embodiments of the present disclosure;

FIG. 8 illustrates an exemplary method for determining symbols not available for PUSCH transmission according to some embodiments of the present disclosure;

FIG. 9 illustrates an exemplary method for determining resources available for PUSCH transmission according to some embodiments of the present disclosure;

FIG. 10 illustrates an exemplary method for determining a rate match pattern applicable for PUSCH transmission according to some embodiments of the present disclosure;

FIG. 11 illustrates an exemplary method for determining resources available for PUSCH transmission according to some other embodiments of the present disclosure;

FIG. 12 is a flow chart illustrating an exemplary method for UL transmission in a full duplex system according to some other embodiments of the present disclosure; and

FIG. 13 illustrates a simplified block diagram of an exemplary apparatus for UL transmission in a full duplex system according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

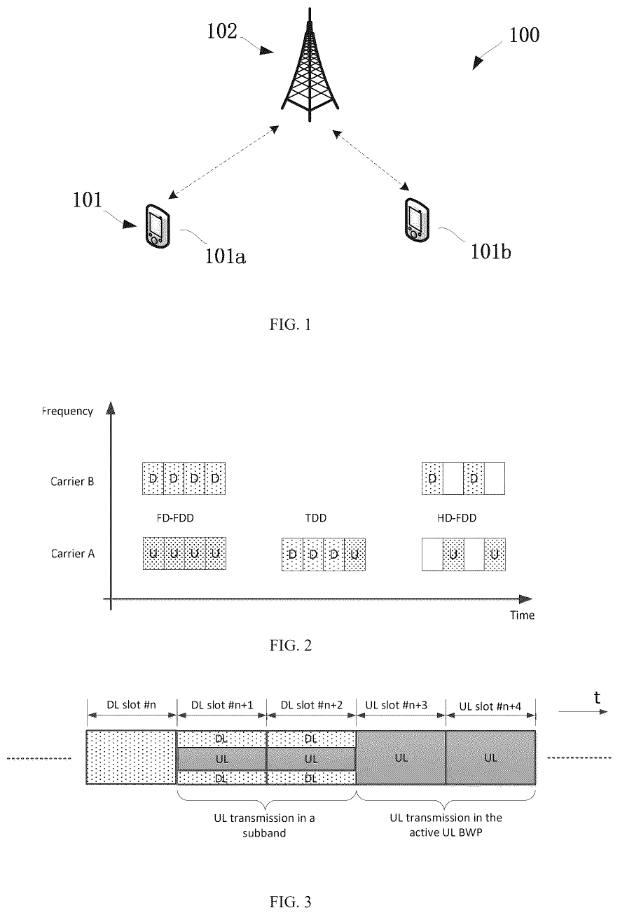

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a BS (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via UL communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time.

FIG. 2 illustrates exemplary duplex modes according to some embodiments of the present disclosure.

Referring to FIG. 2, duplex modes may include, for example, a full duplex frequency division duplex (FD-FDD) mode, a TDD mode, and a half duplex frequency division duplex (HD-FDD) mode.

In some examples, in a full duplex transceiver, different carrier frequencies (e.g., carrier A and carrier B) may be employed for transmissions in each link direction, for example, carrier A may be used for the uplink transmissions while carrier B may be used for the downlink transmissions. Such kind of full duplex may be referred to as the FD-FDD mode.

In a half duplex (HD) transceiver, transmissions in each link direction may be separated by time domain resources. In some cases, the same carrier frequency is used for transmissions in each link direction, for example, carrier A is used for both the uplink and downlink transmissions, such kind of half duplex may be referred to as the TDD mode. In some other cases, different carrier frequencies may be used for transmissions in each link direction, for example, carrier A may be used for the uplink transmissions while carrier B may be used for the downlink transmissions, such kind of half duplex may be referred to as the HD-FDD mode.

Embodiments of the present disclosure provide improvements on the duplex modes, for example, as illustrated in FIG. 2. For example, advanced full duplex modes which enable simultaneous transmission and reception by the same device on the same carrier are provided. The advanced full duplex modes are advantageous. For example, the advanced full duplex modes may improve the link throughput. In addition, the transmission latency in the advanced full duplex modes may also be reduced due to the bidirectional transmission simultaneously.

However, simultaneous DL transmission and UL transmission in the same carrier may incur self-interference. For example, in the BS side, the DL transmission may contaminate UL reception, while in the UE side, the UL transmission may contaminate DL reception.

It is more feasible to realize an advanced full duplex in the BS side than in the UE side due to the following reasons. First, more space is available in the BS side such that transmitter (Tx) and receiver (Rx) antenna branches can be separated for self-interference cancellation. In addition, a more complex and advanced transceiver can be used in the BS side, which may be fundamental for self-interference cancellation.

Given the above, one scenario for implementing a full duplex mode is to deploy an advanced full duplex mode in the BS side only, while still deploying a half duplex mode in the UE side. In such scenario, in a time unit (e.g., a slot) with a full duplex mode, the BS may perform UL receptions from some UEs while performing DL transmissions to some other UEs. Non-overlapped frequency resources in the time unit may be allocated for UL receptions (from some UEs) and DL transmissions (to some other UEs) to mitigate self-interference.

The above scenario may be used in a TDD system to improve UL performance in the TDD system. For example, with the advanced full duplex in the BS side, UL subband(s) may be configured in some DL slots such that the UL transmission can be extended to be within such UL subband(s) in the DL slots while the DL transmission may be scheduled in the resources out of the UL subband(s). Here a subband corresponds to a set of frequency domain resources, e.g., a set of resource elements (REs) or resource blocks (RBs), and may be applicable to a time duration that is configured by a BS. Although the terminology “subband” is used for describing the embodiments of the present disclosure, other terminologies that correspond to a similar resource allocation to the subband, such as bandwidth part, are also applicable to the embodiments of the present disclosure.

FIG. 3 illustrates exemplary radio resources in a TDD system according to some embodiments of the present disclosure.

In some examples, in a TDD system, DL transmissions and UL transmissions may be separated by time domain resources (e.g., slots). For example, the DL transmissions may be performed in DL slots #n-#n+2 as shown in FIG. 3 while the UL transmissions may be performed in the UL slots #n+3-#n+4 as shown in FIG. 3.

A full duplex mode in the BS side may be introduced to the TDD system. For example, for the UEs supporting the full duplex mode in the BS side, in addition to the UL transmission which may be scheduled in the active UL bandwidth parts (BWPs) in the UL slots, the UL transmission may also be scheduled in a subband in the DL slots in the TDD system. As shown in FIG. 3, UL transmissions may occur in a subband in DL slots #n+1 and #n+2. In other words, slot #n+1 and #n+2 are configured with a UL subband(s).

In some embodiment of the present application, reserved resources for DL transmission (i.e., PDSCH transmission) are introduced. One purpose for introducing reserved resources for DL transmission is to allow future extensions without causing backward compatibility issue. For example, the reserved resources cannot be used for DL transmission for legacy UEs, but could be used for future services. Another purpose for introducing reserved resources for DL transmission is to allow reusing unused CORESET resources for PDSCH transmission.

In some embodiments, the reserved resources may be semi-statically configured by a radio resource control (RRC) signaling. For example, the RRC signaling may include configurations of one or more rate match patterns for DL transmission (e.g., PDSCH transmission). A configuration (e.g., RateMatchPattern as specified in 3GPP standard documents) of a rate match pattern may indicate reserved resources for the DL transmission (e.g., PDSCH transmission).

In an embodiment of the present application, a rate match pattern may be configured in a cell level (e.g., in a signaling servingCellConfig or servingCellConfigCommon as specified in 3GPP standard documents). In another embodiment of the present application, a rate match patterns may be configured in a BWP level (e.g., in a PDSCH-config information element (IE) in a singling BWP-ConfigDedicated as specified in 3GPP standard documents).

In an embodiment of the present application, a rate match pattern may be configured in forms of bitmaps. In such embodiment, a configuration of a rate match pattern may include at least one of the following three bitmaps.
Bitmap1: which indicates a resource blocks (RBs) that contain reserved resources.
Bitmap2: which indicates symbols (e.g., OFDM symbols) in a time unit (e.g., 1 slot or 2 slots) that contains reserved resources.
Bitmap3: which indicates time units in a pattern that contain reserved resources. The pattern may have a periodicity. For example, a maximum periodicity of the pattern may be 40 ms.

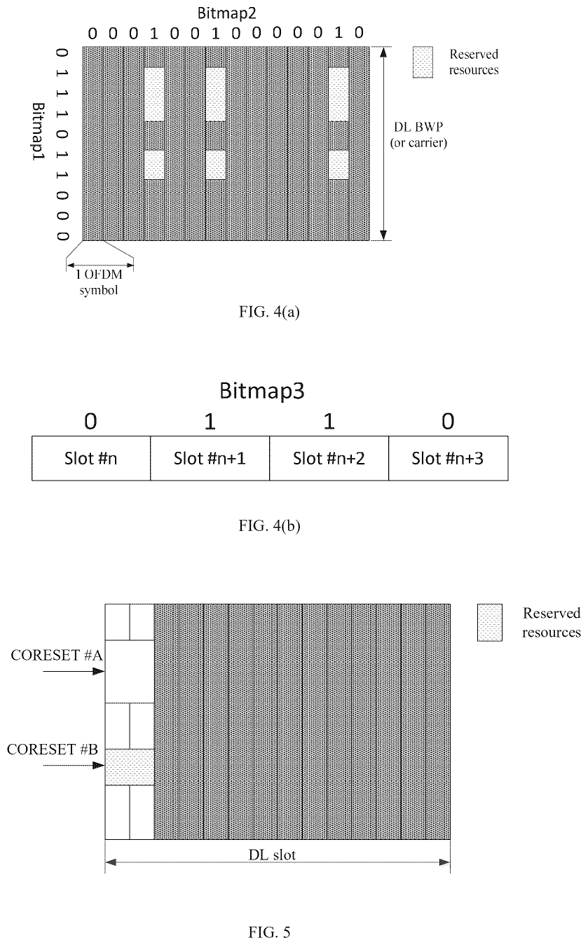

FIGS. 4(a) and 4(b) illustrate exemplary bitmaps in a configuration of a rate match pattern according to some embodiments of the present disclosure.

FIG. 4(a) illustrates exemplary Bitmap1 and Bitmap2 as stated above. Referring to FIG. 4(a), it is assumed that a DL BWP or a carrier includes 10 RBs. Bitmap1 may be “0001101110,” indicating which RBs in the 10 RBs are reserved. For example, bit value “1” may indicate a corresponding RB is reserved, whereas bit value “0” may indicate a corresponding RB is not reserved.

In addition, it is also assumed that a time unit in FIG. 4(a) is one slot including 14 OFDM symbols. Bitmap2 may be “00010010000010,” indicating which OFDM symbols in the slot include the reserved resources (e.g., are reserved). For example, bit value “1” may indicate a corresponding OFDM symbol is reserved, whereas bit value “0” may indicate a corresponding OFDM symbol is not reserved.

Based on Bitmap1 and Bitmap2, the reserved resource in a time unit in a DL BWP of a carrier may be shown in FIG. 4(a).

FIG. 4(b) illustrates exemplary Bitmap3 as stated above. Referring to FIG. 4(b), it is assumed that a periodicity of a pattern is 4 slots. It is further assumed that example, bit value “1” may indicate a corresponding slot is reserved, whereas bit value “0” may indicate a corresponding slot is not reserved. Taking a pattern from slot #n to slot #n+3 as an example, Bitmap3 may indicate which slots in the pattern include the reserved resources (e.g., are reserved). In the case that Bitmap3 is indicated as “0110,” slot #n+1 and slot #n+2 in the pattern in FIG. 4(b) include reserved resource.

In another embodiment of the present application, a rate match pattern may be configured in forms of CORESET ID. In such embodiment, a configuration of a rate match pattern may include an ID of a CORESET. Then, the resources configured for the CORESET may be configured as reserved resources.

FIG. 5 illustrates exemplary CORESETs according to some embodiments of the present disclosure.

FIG. 5 illustrates two CORESETs (e.g., denoted as CORESET #A and CORESET #B). Each CORESET may define a set of resources in a DL slot. It is assumed that a configuration of a rate match pattern includes an ID of CORESET #B. then the resources configured for CORESET #B are configured as reserved resources for the DL transmission.

According to some embodiments of the present application, one or more rate match pattern groups for DL transmission (e.g., PDSCH transmission) may be configured by RRC signaling. For example, the RRC signaling may include configurations of one or more rate match pattern groups (e.g., ratematchpatterngroup1 and ratematchpatterngroup2 as specified in 3GPP standard documents) for DL transmission (e.g., PDSCH transmission). A configuration of a rate match pattern group may indicate one or more rate match patterns. A rate match pattern group may be dynamically activated or deactivated by, for example, DCI scheduling a DL transmission (e.g., PDSCH transmission) (e.g., by DCI format 1_1 or DCI format 1_2). In the case that a rate match pattern group is activated (also referred to as “reserved resources defined by all rate match patterns in the rate match pattern group are activated”), the DL transmission cannot be transmitted in reserved resources defined by all rate match patterns in the rate match pattern group and may be rate matched around the reserved resources; otherwise (i.e., in the case that the rate match pattern group is deactivated), the reserved resources can be used for DL transmission.

In some embodiments of the present application, for a rate match pattern which is not included in a rate match pattern group, it may be activated or deactivated via RRC signaling (in other words, the reserved resources configured by the rate match pattern may be activated or deactivated via RRC signaling). In some embodiments, the BS and the UE may consider that such rate match pattern is always activated until receiving RRC signaling to deactivate it.

Generally, reserved resources may be not be configured for UL transmission. One reason is that configuration reserved resources for UL transmission may result in non-contiguous frequency-domain allocations, which is basically not supported by UL transmission due to high peak to average power ratio (PAPR). In some examples, avoiding UL transmission on some resources may be achieved via scheduling by the BS.

As stated above, in a TDD system with a full duplex mode in the BS side, UL subband(s) may be configured in some DL slots for UL transmission (e.g., PUSCH transmission). In such scenarios, the reserved resources configured for DL transmission may be within the bandwidth (BW) of the UL subband(s) configured for the UL transmission. Embodiments of the present disclosure provide solutions for handling the above case. For example, the UE behavior regarding whether the reserved resource for DL transmission is available or not for UL transmission are defined.

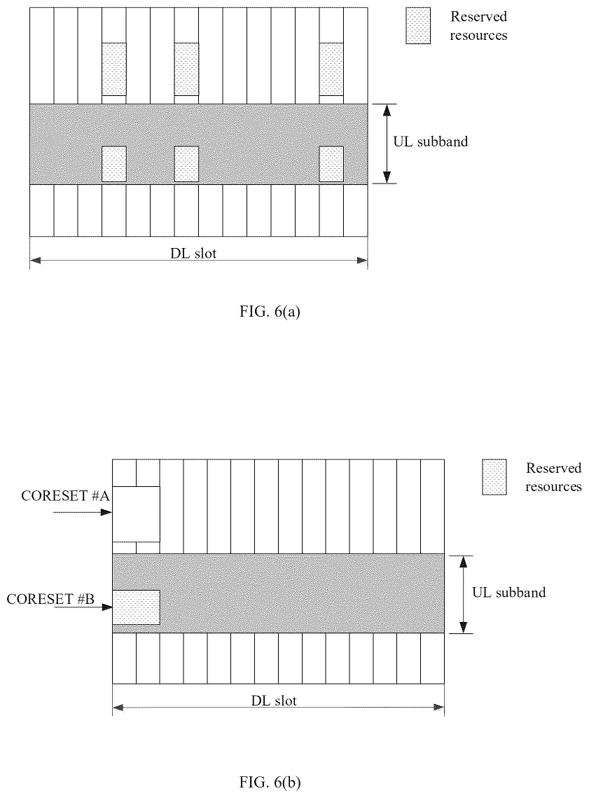

FIGS. 6(a) and 6(b) illustrate examples in which the reserved resources for DL transmission are in a UL subband for UL transmission according to some embodiments of the present disclosure.

Referring to in FIG. 6(a), it is assumed that a rate match pattern is configured in forms of bitmaps as stated above. It can be seen that a part of reserved resources configured by the rate match pattern is within the BW of a UL subband configured for UL transmission in a DL slot.

Referring to FIG. 6(b), it is assumed that a rate match pattern is configured in forms of CORESET IDs as stated above. For example, the configuration of a rate match pattern includes an ID of CORESET #B, which means that the resources configured for CORESET #B are configured as reserved resources for DL transmission. It can be seen that the reserved resources configured by CORESET #B are within the BW of a UL subband configured for UL transmission in a DL slot.

Embodiments of the present application provide solutions for UL transmission in a full duplex system. For example, embodiments of the present application propose solutions regarding how to determine whether resources in a UL subband are available or not for UL transmission when the UL subband includes reserved resources. Solutions in the embodiments of the present disclosure can facilitate UL transmissions in DL slots, thereby achieving better UL coverage, lower UL transmission latency and improved UL capability. More details on embodiments of the present application will be described in the following text in combination with the appended drawings.

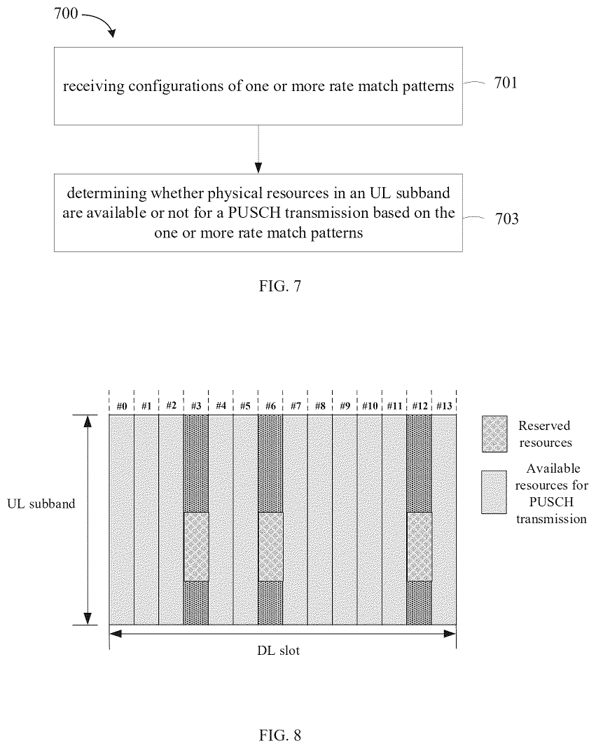

FIG. 7 is a flow chart illustrating an exemplary method 700 for UL transmission in a full duplex system according to some embodiments of the present disclosure. The method in FIG. 7 may be implemented by a UE (e.g., UE 101 as shown in FIG. 1).

In the exemplary method shown in FIG. 7, in step 701, a UE may receive configurations of one or more rate match patterns from a BS (e.g., BS 102 as shown in FIG. 1). In step 703, the UE may determine whether physical resources in a UL subband are available or not for a PUSCH transmission based on the one or more rate match patterns.

According to some embodiments of the present disclosure, the one or more rate match patterns may be configured for a PDSCH transmission. All the above definitions regarding the configuration of a rate match pattern for DL transmission may apply here. That is, in such embodiments, a configuration of a rate match pattern may indicate reserved resources for the PDSCH transmission. For example, a configuration of a rate match pattern may be RateMatchPattern as specified in 3GPP standard documents.

In some embodiments of the present application, the UE may receive configurations of one or more rate match pattern groups for a PDSCH transmission. All the above definitions regarding the configuration of a rate match pattern group for DL transmission may apply here.

The following embodiments provide several methods for determining whether physical resources in the UL subband are available or not for the PUSCH transmission.

In an embodiment of the present application, in the case that resources allocated for the PUSCH transmission in the UL subband include reserved resources configured by a rate match pattern in the one or more rate match patterns, the UE may determine that a whole symbol(s) (e.g., OFDM symbols) including the reserved resources in the resources allocated for the PUSCH transmission is not available for the PUSCH transmission.

In such embodiment, the UE may determine that a whole symbol(s) (e.g., OFDM symbols) including the reserved resources in the resources allocated for the PUSCH transmission is not available for the PUSCH transmission no matter the rate match pattern is within a rate match pattern group of the one or more rate match pattern groups or not. In other words, even if the rate match pattern or the reserved resources configured by the rate match pattern are included in a rate match pattern group and are deactivated, the UE may determine that the whole symbol(s) (e.g., OFDM symbols) including the reserved resources in the resources allocated for the PUSCH transmission is not available for the PUSCH transmission.

FIG. 8 illustrates an exemplary method for determining symbols not available for PUSCH transmission according to some embodiments of the present disclosure.

Referring to FIG. 8, it is assumed that a DL slot includes 14 OFDM symbols (e.g., denoted as OFDM symbol #0 to OFDM symbol #13) and includes a UL subband for PUSCH transmission. In the example of FIG. 8, it is assumed that all the resources in the UL subband are scheduled for a PUSCH transmission of a UE.

The UE may receive configurations of one or more rate match patterns for PDSCH transmission from the BS. According to a configuration of a rate match pattern, the UE may determine OFDM symbols #3, #6 and #12 in the UL subband include reserved resources configured by the rate match pattern, then the UE may determine that the whole OFDM symbols #3, #6 and #12 in the UL subband are not available for the PUSCH transmission.

It should be noted that some of the resources in a UL subband may not be scheduled for a PUSCH transmission in some other examples. In these examples, the whole OFDM symbol(s) including reserved resources configured by a rate match pattern in the resources scheduled for the PUSCH transmission are not available for the PUSCH transmission.

In another embodiment of the present application, in the case that resources allocated for the PUSCH transmission in the UL subband include reserved resources configured by a rate match pattern in the one or more rate match patterns and the rate match pattern is within a rate match pattern group of the one or more rate match pattern groups, the UE may determine that the reserved resources are available for the PUSCH transmission.

In such embodiment, the BS may avoid to scheduling resources for a PDSCH transmission in a symbol(s) including the reserved resources if they are activated.

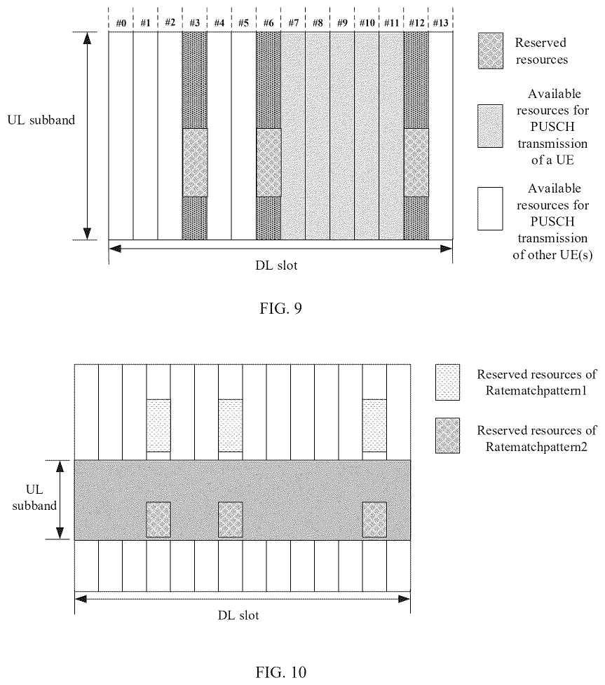

FIG. 9 illustrates an exemplary method for determining resources available for PUSCH transmission according to some embodiments of the present disclosure.

Referring to FIG. 9, it is assumed that a DL slot includes 14 OFDM symbols (e.g., denoted as OFDM symbol #0 to OFDM symbol #13) and includes a UL subband for PUSCH transmission.

The UE may receive configurations of one or more rate match patterns for PDSCH transmission from the BS. According to a configuration of a rate match pattern, the UE may determine that OFDM symbols #3, #6 and #12 in the UL subband include reserved resources configured by the rate match pattern. In addition, the UE may determine that the rate match pattern is within a rate match pattern group configured by the BS.

In FIG. 9, it is assumed that the reserved resources configured by the rate match pattern are activated, the BS may not schedule resource which includes the reserved resources for PUSCH transmission. In some examples, the BS may schedule resources in OFDM symbol #7 to OFDM symbol #11 for the PUSCH transmission of a UE. The BS may schedule resources in OFDM symbol #0 to OFDM symbol #2, OFDM symbol #4 to OFDM symbol #5, and OFDM symbol #13 for PUSCH transmissions for other UE(s).

After receiving the resources scheduled by the BS for the PUSCH transmission, the UE may determine or know that the reserved resources in OFDM symbols #3, #6 and #12 are not available for the PUSCH transmission because the scheduled resources for the PUSCH transmission do not include the reserved resources.

FIG. 9 illustrates an example in which the reserved resources are activated. However, in another example, when the reserved resources are deactivated, the BS may schedule resource which includes the reserved resources for the PUSCH transmission of the UE. For example, the BS may schedule resources in OFDM symbol #4 to OFDM symbol #12 for the PUSCH transmission of a UE. Then, after receiving the scheduling resources from the BS, the UE may determine or know that the reserved resources in OFDM symbols #6 and #12 are available for the PUSCH transmission because the scheduled resources for PUSCH transmission include the reserved resources.

In the above embodiments, the UE is not explicitly aware of whether the reserved resources are deactivated or not. The methods in the above embodiments may be simpler to be implemented, but may have relatively lower resource usage efficiency and less scheduling flexibility.

In the following embodiments of the present disclosure, the UE is explicitly aware of whether the reserved resources are deactivated or activated. The methods in the following embodiments may achieve better resource utilization efficiency compared with the above embodiments.

According to some embodiments of the present disclosure, the one or more rate match patterns may be configured for a PDSCH transmission. All the above definitions regarding the configuration of a rate match pattern for DL transmission may apply here. That is, in such embodiments, a configuration of a rate match pattern may indicate reserved resources for the PDSCH transmission. For example, a configuration of a rate match pattern may be RateMatchPattern as specified in 3GPP standard documents.

The UE may determine at least one rate match pattern applicable for the PUSCH transmission based on the one or more rate match patterns.

In some embodiments of the present application, in the case that reserved resources configured by a rate match pattern in the one or more rate match patterns are fully or partly within resources allocated for the PUSCH transmission in the UL subband, the UE may determine that the rate match pattern in the one or more rate match patterns is a rate match pattern applicable for the PUSCH transmission.

In some examples, a rate match pattern may be configured in forms of bitmaps. For example, a configuration of a rate match pattern may include three bitmaps (e.g., Bitmap1, Bitmap2, and Bitmap3) as stated above. In such examples, reserved resources configured by a rate match pattern being fully or partly within resources (e.g., physical resources) allocated for the PUSCH transmission in the UL subband may mean that physical resources determined by bitmaps in the configuration of the rate match pattern are fully or partly within resources (e.g., physical resources) allocated for the PUSCH transmission.

In some examples, a rate match pattern may be configured in forms of CORESET ID. For example, a configuration of a rate match pattern may include an ID of a CORESET as stated above. In such examples, reserved resources configured by a rate match pattern in the one or more rate match patterns being fully or partly within resources (e.g., physical resources) allocated for the PUSCH transmission in the UL subband may mean that physical resources determined by a CORESET (indicated by a CORESET ID in the rate match pattern) are fully or partly within resources (e.g., physical resources) allocated for the PUSCH transmission.

In some embodiments of the present disclosure, the UE may receive a configuration(s) of one or more rate match pattern groups for a PDSCH transmission. All the above definitions regarding the configuration of a rate match pattern group for DL transmission may apply here.

Then, the UE may determine that a rate match pattern group in the one or more rate match pattern groups is applicable for the PUSCH transmission in the case that reserved resources configured by a rate match pattern in the rate match pattern group are fully or partly within resources allocated for the PUSCH transmission in the UL subband.

In an embodiment of the present application, the UE may determine that at least one rate match pattern group in the one or more rate match pattern groups is applicable for the PUSCH transmission. Each of the at least one rate match pattern group may be dynamically activated or deactivated for the PUSCH transmission via a DCI scheduling the PUSCH transmission.

In such embodiment, the UE may receive DCI scheduling the PUSCH transmission. For example, the DCI may be DCI format 0_1, DCI format 0_2, or a dedicated DCI for scheduling a PUSCH transmission in the UL subband. The DCI may include an indication indicating at least one of: whether the at least one rate match pattern group is activated or deactivated, which rate match pattern group(s) is activated, or which rate match pattern group(s) is deactivated. In other words, the DCI may include an indication indicating whether a rate match pattern group applicable for the PUSCH transmission is activated or deactivated.

For example, in the case that one rate match pattern group is determined to be applicable for the PUSCH transmission, the DCI may include an indication indicating whether the one rate match pattern group is activated or deactivated.

In another example, in the case that two rate match pattern groups are determined to be applicable for the PUSCH transmission, the DCI may include an indication indicating one of: the two rate match pattern groups are activated, the two rate match pattern groups are deactivated, a first rate match pattern group in the two rate match pattern groups is activated and a second rate match pattern group in the two rate match pattern groups is deactivated, and the first rate match pattern group in the two rate match pattern groups is deactivated and the second rate match pattern group in the two rate match pattern groups is activated.

In the above embodiments, if a rate match pattern group includes at least one rate match pattern applicable for the PUSCH transmission, the rate match pattern group being activated may mean that all of the at least one rate match pattern is activated, which also means that all the reserved resources configured by the activated at least one rate match pattern and included in resources allocated for the PUSCH transmission in the UL subband are activated. Similarly, the rate match pattern group being deactivated may mean that all of the at least one rate match pattern is deactivated, which also means that all the reserved resources configured by the deactivated at least one rate match pattern and included in resources allocated for the PUSCH transmission in the UL subband are deactivated.

FIG. 10 illustrates an exemplary method for determining a rate match pattern applicable for PUSCH transmission according to some embodiments of the present disclosure.

Referring to FIG. 10, it is assumed that the UE receives the configuration(s) of two rate match patterns (e.g., denoted as RateMatchPattern1 and RateMatchPattern2) for PDSCH transmissions.

Based on the configuration(s) of RateMatchPattern1 and RateMatchPattern2, the UE may determine that the reserved resources configured by RateMatchPattern2 are fully within the UL subband whereas the reserved resources configured by RateMatchPattern1 are out of the UL subband.

The UE may determine that RateMatchPattern2 is applicable for the PUSCH transmission in the UL subband in the case that the reserved resources configured by RateMatchPattern2 are fully or partly within resources allocated for the PUSCH transmission in the UL subband. In addition, when RateMatchPattern2 is included in a rate match pattern group, it can be dynamically activated or deactivated based on the methods as stated above.

Based on the at least one rate match pattern group applicable for the PUSCH transmission, the UE may determine activated rate match pattern(s) in the at least one rate match pattern applicable for the PUSCH transmission. For example, for a rate match pattern included in a rate match pattern group, the UE may determine that it is activated in the case that the rate match pattern group is activated, or the UE may determine that it is deactivated in the case that the rate match pattern group is deactivated. In another example, for a rate match pattern which is not included in a rate match pattern group, the UE may determine that it is activated until receiving RRC signaling to deactivate it.

The UE may determine whether physical resources in the UL subband are available or not for the PUSCH transmission based on the activated rate match pattern(s) applicable for the PUSCH transmission. For example, in the case that a symbol in resources allocated for the PUSCH transmission in the UL subband includes reserved resources configured by an activated rate match pattern(s) applicable for the PUSCH transmission, the UE may determine a frequency domain region out of the reserved resources in the symbol that includes a maximum number of consecutive resource units (e.g., a resource unit may be a resource block or a resource element (RE)) is available for the PUSCH transmission Alternatively, the UE may determine that the symbol is not available for the PUSCH transmission. In some embodiments, the activated rate match pattern(s) applicable for the PUSCH transmission may refer to all activated rate match pattern(s) applicable for the PUSCH transmission.

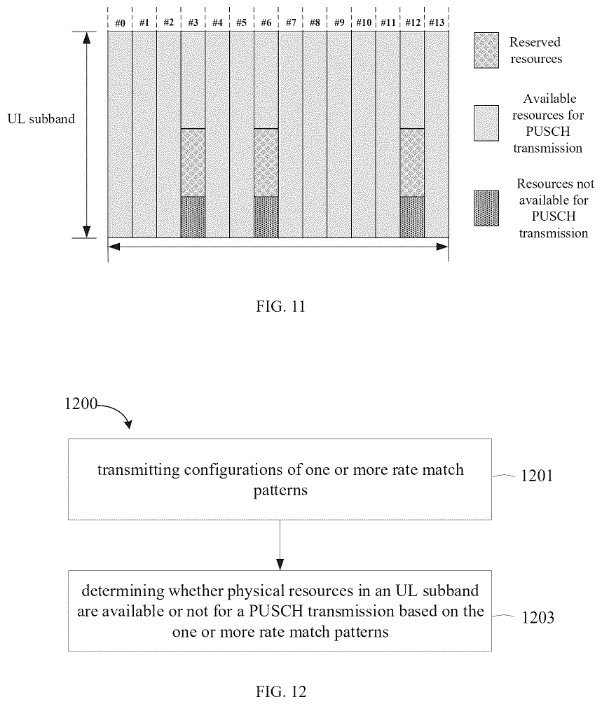

FIG. 11 illustrates an exemplary method for determining resources available for PUSCH transmission according to some other embodiments of the present disclosure.

Referring to FIG. 11, it is assumed that a DL slot includes 14 OFDM symbols (e.g., denoted as OFDM symbol #0 to OFDM symbol #13) and includes a UL subband for PUSCH transmission. In the example of FIG. 11, it is assumed that all the resources in the UL subband are scheduled for a PUSCH transmission of a UE. It should be noted that some of the resources in a UL subband may not be scheduled for a PUSCH transmission in some other examples.

The UE may receive configurations of one or more rate match patterns for PDSCH transmission from the BS. In the example of FIG. 11, it is assumed that at least one rate match pattern in the one or more rate match patterns is activated and applicable for the PUSCH transmission, and OFDM symbols #3, #6 and #12 have reserved resources configured by the at least one activated rate match pattern applicable for the PUSCH transmission.

Based on the above embodiments, the UE may determine that a frequency domain region out of the reserved resources in the symbol that includes a maximum number of consecutive resource units is available for the PUSCH transmission. Referring to FIG. 11, it can be seen that for the physical resources out of the reserved resources in OFDM symbols #3, #6 and #12, the upper frequency domain regions in OFDM symbols #3, #6 and #12 include more consecutive RBs (or REs), and thus may be determined as available for the PUSCH transmission. The lower frequency domain regions in OFDM symbols #3, #6 and #12 are not available for the PUSCH transmission. Accordingly, the PUSCH transmission may be rate matched around the reserved resources and resources not available for the PUSCH transmission in OFDM symbols #3, #6 and #12.

According to some embodiments of the present application, the one or more rate match patterns are configured for the PUSCH transmission.

In some embodiments of the present disclosure, a configuration of a rate match pattern for the PUSCH transmission may be similar to a configuration of a rate match pattern for the PDSCH transmission. For example, a rate match pattern for the PUSCH transmission may be configured in forms of bitmaps or CORESET ID to indicate the reserved resource of the PUSCH transmission.

In an embodiment of the present disclosure, a configuration of a rate match pattern for a PUSCH transmission includes at least one bitmap indicating reserved resources, and the at least one bitmap is configured based on at least one of: a configuration for the UL subband; or a slot including the UL subband.

For example, a configuration of a rate match pattern for the PUSCH transmission may include three bitmaps denoted as Bitmap1′, Bitmap2′, and Bitmap3′. Bitmap2 as stated above may be reused as Bitmap2′. The difference between Bitmap1′ and Bitmap1 may include that Bitmap1′ is configured within the BW of the UL subband, and the difference between Bitmap3′ and Bitmap3 may include that Bitmap3′ is configured based on the slot(s) including the UL subband.

For example, the definitions regarding Bitmap1′, Bitmap2′, and Bitmap3′ may be as follows.
Bitmap1′: which indicates a resource blocks (RBs) within the BW of the UL subband that contain reserved resources.
Bitmap2′: which indicates symbols (e.g., OFDM symbols) within the symbols applicable for subband in a time unit (e.g., 1 slot or 2 slots) that contains reserved resources.
Bitmap3′: which indicates time units in slots with UL subband that contain reserved resources.

In another embodiment of the present disclosure, a configuration of a rate match pattern includes an ID of a CORESET including reserved resources and an ID of a BWP associated with the CORESET (optional). In such embodiments, including an ID of a BWP in the configuration may facilitate the recognition of the correct CORESET since a UL subband may include resources of more than one BWP and the same CORESET ID may determine different resources in the more than one BWP, and in this scenario, without the ID of a BWP, the UE cannot determine resources in which BWP are the reserved resources.

In some embodiments of the present application, a rate match pattern of the one or more rate match patterns for PUSCH transmission may be associated with (e.g., mapped to) a corresponding rate match pattern for a PDSCH transmission. In such embodiments, a configuration of a rate match pattern may indicate that the rate match pattern is associated with a corresponding rate match pattern for a PDSCH transmission. A rate match pattern of the one or more rate match patterns may include reserved resources configured by the corresponding rate match pattern for the PDSCH transmission and is within the UL subband.

In some embodiments of the present disclosure, the UE may receive a configuration(s) of one or more rate match pattern groups for a PUSCH transmission. Each rate match pattern group for a PUSCH transmission may include at least one rate match pattern for the PUSCH transmission.

In an embodiment, the UE may receive DCI scheduling the PUSCH transmission. For example, the DCI may be DCI format 0_1, DCI format 0_2, or a dedicated DCI for scheduling a PUSCH transmission in the UL subband. The DCI may include an indication indicating at least one of: whether the one or more match pattern groups are activated or deactivated, which rate match pattern group(s) is activated and, or rate match pattern group(s) is deactivated.

For example, in the case that one rate match pattern group is configured for the PUSCH transmission, the DCI may include an indication indicating whether the one rate match pattern group is activated or deactivated.

In another example, in the case that two rate match pattern groups are configured for the PUSCH transmission, the DCI may include an indication indicating one of: the two rate match pattern groups are activated, the two rate match pattern groups are deactivated, a first rate match pattern group in the two rate match pattern groups is activated and a second rate match pattern group in the two rate match pattern groups is deactivated, and the first rate match pattern group in the two rate match pattern groups is deactivated and the second rate match pattern group in the two rate match pattern groups is activated.

In the above embodiments, if a rate match pattern group includes at least one rate match pattern applicable for the PUSCH transmission, a rate match pattern group being activated may mean that all of the at least one rate match pattern is activated, which also means that all the reserved resources configured by the activated at least one rate match pattern and included in resources allocated for the PUSCH transmission in the UL subband are activated. Similarly, the rate match pattern group being deactivated may mean that all of the at least one rate match pattern is deactivated, which also means that all the reserved resources configured by the deactivated at least one rate match pattern and included in resources allocated for the PUSCH transmission in the UL subband are deactivated.

Based on the one or more rate match pattern groups configured for the PUSCH transmission, the UE may determine activated rate match pattern(s) in the one or more rate match patterns for the PUSCH transmission. For example, for a rate match pattern included in a rate match pattern group, the UE may determine that it is activated in the case that the rate match pattern group is activated, or the UE may determine that it is deactivated in the case that the rate match pattern group is deactivated. In another example, for a rate match pattern which is not included in a rate match pattern group, the UE may determine that it is activated until receiving RRC signaling to deactivate it.

Then, the UE may determine whether physical resources in the UL subband are available or not for the PUSCH transmission based on the activated rate match pattern(s) in the one or more rate match patterns for the PUSCH transmission. For example, in the case that a symbol in resources allocated for the PUSCH transmission in the UL subband includes reserved resources configured by an activated rate match pattern(s) in the one or more rate match patterns for the PUSCH transmission, the UE may determine a frequency domain region out of the reserved resources in the symbol that includes a maximum number of consecutive resource units (e.g., a resource unit may be a resource block or a resource element (RE)) is available for the PUSCH transmission (e.g., an example for this operation may refer to FIG. 11). Alternatively, the UE may determine that the symbol is not available for the PUSCH transmission. In some examples, the activated rate match pattern(s) in the one or more rate match patterns for the PUSCH transmission may refer to all activated rate match pattern(s) in the one or more rate match patterns for the PUSCH transmission.

FIG. 12 is a flow chart illustrating an exemplary method 1200 for UL transmission in a full duplex system according to some embodiments of the present disclosure. The method in FIG. 12 may be implemented by a BS (e.g., BS 102 as shown in FIG. 1).

In the exemplary method shown in FIG. 12, in step 1201, the BS may transmit, to a UE (e.g., UE 101 as shown in FIG. 1), configurations of one or more rate match patterns. In step 1203, the BS may determine whether physical resources in UL subband are available or not for a PUSCH transmission based on the one or more rate match patterns.

According to some embodiments of the present disclosure, the one or more rate match patterns may be configured for a PDSCH transmission. All the above definitions regarding the configuration of a rate match pattern for DL transmission may apply here. That is, in such embodiments, a configuration of a rate match pattern may indicate reserved resources for the PDSCH transmission. For example, a configuration of a rate match pattern may be RateMatchPattern as specified in 3GPP standard documents.

In some embodiments of the present application, the BS may transmit configurations of one or more rate match pattern groups for a PDSCH transmission. All the above definitions regarding the configuration of a rate match pattern group for DL transmission may apply here.

The following embodiments provide several methods for determining whether physical resources in the UL subband are available or not for the PUSCH transmission.

In an embodiment of the present application, in the case that resources allocated for the PUSCH transmission in the UL subband include reserved resources configured by a rate match pattern in the one or more rate match patterns, the BS may determine that a whole symbol(s) (e.g., OFDM symbols) including the reserved resources in the resources allocated for the PUSCH transmission is not available for the PUSCH transmission.

In such embodiment, the BS may determine that a whole symbol(s) (e.g., OFDM symbols) including the reserved resources in the resources allocated for the PUSCH transmission is not available for the PUSCH transmission no matter the rate match pattern is within a rate match pattern group of the one or more rate match pattern groups or not or no matter the rate match pattern is activated or not. In other words, even if the rate match pattern or the reserved resources configured by the rate match pattern are deactivated, the BS may determine that the whole symbol(s) (e.g., OFDM symbol(s)) including the reserved resources in the resources allocated for the PUSCH transmission is not available for the PUSCH transmission. An example for determining symbols not available for PUSCH transmission may refer to FIG. 8.

In another embodiment of the present application, in the case that a rate match pattern in the one or more rate match patterns is within a rate match pattern group of the one or more rate match pattern groups, the BS may determine that the reserved resources configured by the rate match pattern are available for the PUSCH transmission when the rate match pattern group is deactivated. Alternatively, the BS may determine that the reserved resources configured by the rate match pattern are not available for the PUSCH transmission when the rate match pattern group is activated. In such embodiment, the BS may avoid to schedule resources for a PDSCH transmission in a symbol(s) including the reserved resources if they are activated. An example for determining resources available for PUSCH transmission may refer to FIG. 9.

According to some embodiments of the present disclosure, the one or more rate match patterns may be configured for a PDSCH transmission. All the above definitions regarding the configuration of a rate match pattern for DL transmission may apply here. That is, in such embodiments, a configuration of a rate match pattern may indicate reserved resources for the PDSCH transmission. For example, a configuration of a rate match pattern may be RateMatchPattern as specified in 3GPP standard documents.

The BS may determine at least one rate match pattern applicable for the PUSCH transmission based on the one or more rate match patterns.

In some embodiments of the present application, in the case that reserved resources configured by a rate match pattern in the one or more rate match patterns are fully or partly within resources allocated for the PUSCH transmission in the UL subband, the BS may determine that the rate match pattern in the one or more rate match patterns is a rate match pattern applicable for the PUSCH transmission. An example for determining a rate match pattern applicable for the PUSCH transmission may refer to FIG. 10.

In some embodiments of the present disclosure, the BS may receive configurations of one or more rate match pattern groups for a PDSCH transmission. All the above definitions regarding the configuration of a rate match pattern group for DL transmission may apply here.

The BS may determine that a rate match pattern group in the one or more rate match pattern groups is applicable for the PUSCH transmission in the case that reserved resources configured by a rate match pattern in the rate match pattern group are fully or partly within resources allocated for the PUSCH transmission in the UL subband.

In an embodiment of the present application, the BS may determine that at least one rate match pattern group in the one or more rate match pattern groups is applicable for the PUSCH transmission. Each of the at least one rate match pattern group may be dynamically activated or deactivated for the PUSCH transmission via a DCI scheduling the PUSCH transmission

In such embodiment, the BS may transmit DCI scheduling the PUSCH transmission. For example, the DCI may be DCI format 0_1, DCI format 0_2, or a dedicated DCI for scheduling a PUSCH transmission in the UL subband. The DCI may include an indication indicating at least one of: whether the at least one rate match pattern group is activated or deactivated, which rate match pattern group(s) is activated, or which rate match pattern group(s) is deactivated. In other words, the DCI may include an indication indicating whether a rate match pattern group applicable for the PUSCH transmission is activated or deactivated.

Based on the at least one rate match pattern group applicable for the PUSCH transmission, the BS may determine activated rate match pattern(s) in the at least one rate match pattern applicable for the PUSCH transmission. The BS may use the same methods as those used by the UE to determine activated rate match pattern(s).

The BS may determine whether physical resources in the UL subband are available or not for the PUSCH transmission based on the activated rate match pattern(s) applicable for the PUSCH transmission. For example, in the case that a symbol in resources allocated for the PUSCH transmission in the UL subband includes reserved resources configured by an activated rate match pattern(s) applicable for the PUSCH transmission, the BS may determine a frequency domain region out of the reserved resources in the symbol that includes a maximum number of consecutive resource units (e.g., a resource unit may be a resource block or a resource element (RE)) is available for the PUSCH transmission. An example for determining resources available for PUSCH transmission may refer to FIG. 11. Alternatively, the BS may determine that the symbol is not available for the PUSCH transmission. In some embodiments, the activated rate match pattern(s) applicable for the PUSCH transmission may refer to all activated rate match pattern(s) applicable for the PUSCH transmission.

According to some embodiments of the present application, the one or more rate match patterns are configured for the PUSCH transmission.

In some embodiments of the present disclosure, a configuration of a rate match pattern for the PUSCH transmission may be similar to a configuration of a rate match pattern for the PDSCH transmission. For example, a rate match pattern for the PUSCH transmission may be configured in forms of bitmaps or CORESET ID to indicate the reserved resource of the PUSCH transmission.

In an embodiment of the present disclosure, a configuration of a rate match pattern for a PUSCH transmission includes at least one bitmap indicating reserved resources, and the at least one bitmap is configured based on at least one of: a configuration for the UL subband; or a slot including the UL subband.

In another embodiment of the present disclosure, a configuration of a rate match pattern includes an ID of a CORESET including reserved resources and an ID of a BWP associated with the CORESET (optional).

In some embodiments of the present application, a rate match pattern of the one or more rate match patterns for PUSCH transmission may be associated with (e.g., mapped to) a corresponding rate match pattern for a PDSCH transmission. In such embodiments, a configuration of a rate match pattern may indicate that the rate match pattern is associated with a corresponding rate match pattern for a PDSCH transmission. A rate match pattern of the one or more rate match patterns may include reserved resources configured by the corresponding rate match pattern for the PDSCH transmission and is within the UL subband.

In some embodiments of the present disclosure, the BS may transmit configuration(s) of one or more rate match pattern groups for a PUSCH transmission. Each rate match pattern group for a PUSCH transmission may include at least one rate match pattern for the PUSCH transmission.

In an embodiment, the BS may receive DCI scheduling the PUSCH transmission. For example, the DCI may be DCI format 0_1, DCI format 0_2, or a dedicated DCI for scheduling a PUSCH transmission in the UL subband. The DCI may include an indication indicating at least one of: whether the one or more match pattern groups are activated or deactivated, which rate match pattern group(s) is activated or which rate match pattern group(s) is deactivated.

Based on the one or more rate match pattern groups configured for the PUSCH transmission, the BS may determine activated rate match pattern(s) in the one or more rate match patterns for the PUSCH transmission. The BS may use the same methods as those used by the UE to determine activated rate match pattern(s) in the one or more rate match patterns for the PUSCH transmission.

Then, the BS may determine whether physical resources in the UL subband are available or not for the PUSCH transmission based on the activated rate match pattern(s) in the one or more rate match patterns for the PUSCH transmission. For example, in the case that a symbol in resources allocated for the PUSCH transmission in the UL subband includes reserved resources configured by an activated rate match pattern(s) in the one or more rate match patterns for the PUSCH transmission, the BS may determine a frequency domain region out of the reserved resources in the symbol that includes a maximum number of consecutive resource units (e.g., a resource unit may be a resource block or a resource element (RE)) is available for the PUSCH transmission (e.g., an example for this operation may refer to FIG. 11). Alternatively, the BS may determine that the symbol is not available for the PUSCH transmission. In some examples, the activated rate match pattern(s) in the one or more rate match patterns for the PUSCH transmission may refer to all activated rate match pattern(s) in the one or more rate match patterns for the PUSCH transmission.

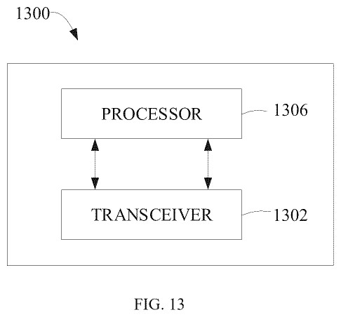

FIG. 13 illustrates a block diagram of an exemplary apparatus 1300 according to some embodiments of the present disclosure. As shown in FIG. 13, the apparatus 1300 may include at least one processor 1306 and at least one transceiver 1302 coupled to the processor 1306. The apparatus 1300 may be a UE or a BS.

Although in this figure, elements such as the at least one transceiver 1302 and processor 1306 are described in the singular, the plural is contemplated unless a limitation to the singular is explicitly stated. In some embodiments of the present disclosure, the transceiver 1302 may be divided into two devices, such as a receiving circuitry and a transmitting circuitry. In some embodiments of the present disclosure, the apparatus 1300 may further include an input device, a memory, and/or other components.

In some embodiments of the present disclosure, the apparatus 1300 may be a UE. The transceiver 1302 and the processor 1306 may interact with each other so as to perform the operations with respect to the UE described in FIGS. 1-12. In some embodiments of the present disclosure, the apparatus 1300 may be a BS. The transceiver 1302 and the processor 1306 may interact with each other so as to perform the operations with respect to the BS described in FIGS. 1-12.

In some embodiments of the present disclosure, the apparatus 1300 may further include at least one non-transitory computer-readable medium.

For example, in some embodiments of the present disclosure, the non-transitory computer-readable medium may have stored thereon computer-executable instructions to cause the processor 1306 to implement the method with respect to the UE as described above. For example, the computer-executable instructions, when executed, cause the processor 1306 interacting with transceiver 1302 to perform the operations with respect to the UE described in FIGS. 1-12.

In some embodiments of the present disclosure, the non-transitory computer-readable medium may have stored thereon computer-executable instructions to cause the processor 1306 to implement the method with respect to the BS as described above. For example, the computer-executable instructions, when executed, cause the processor 1306 interacting with transceiver 1302 to perform the operations with respect to the BS described in FIGS. 1-12.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE) for wireless communication, comprising:
at least one memory; and
at least one processor coupled with the at least one memory and configured to cause the UE to:
receive configurations of one or more rate match patterns; and
determine whether physical resources in an uplink (UL) subband are available or not for a physical uplink shared channel (PUSCH) transmission based at least in part on the one or more rate match patterns.

2. The UE of claim 1, wherein the one or more rate match patterns are configured for a physical downlink shared channel (PDSCH) transmission, and wherein to determine whether physical resources in the UL subband are available or not for the PUSCH transmission, the at least one processor is configured to cause the UE to:
in a case that resources allocated for the PUSCH transmission in the UL subband include reserved resources configured by a rate match pattern in the one or more rate match patterns, determine that a whole symbol(s) including the reserved resources in the resources allocated for the PUSCH transmission is not available for the PUSCH transmission.

3. The UE of claim 1, wherein the one or more rate match patterns are configured for a physical downlink shared channel (PDSCH) transmission, and wherein to determine whether physical resources in the UL subband are available or not for the PUSCH transmission, the at least one processor is configured to cause the UE to:
in a case that resources allocated for the PUSCH transmission in the UL subband include reserved resources configured by a rate match pattern in the one or more rate match patterns and the rate match pattern is within a rate match pattern group, determine that the reserved resources are available for the PUSCH transmission.

4. The UE of claim 1, wherein the one or more rate match patterns are configured for a physical downlink shared channel (PDSCH) transmission, and the processor is further configured to determine at least one rate match pattern applicable for the PUSCH transmission based at least in part on the one or more rate match patterns.

5. The UE of claim 4, wherein to determine the at least one rate match pattern applicable for the PUSCH transmission based at least in part on the one or more rate match patterns, the at least one processor is configured to cause the UE to, in a case that reserved resources configured by a rate match pattern in the one or more rate match patterns are fully or partly within resources allocated for the PUSCH transmission in the UL subband, determine that the rate match pattern in the one or more rate match patterns is a rate match pattern applicable for the PUSCH transmission.

6. The UE of claim 4, wherein to determine whether physical resources in the UL subband are available or not for the PUSCH transmission, the at least one processor is configured to, in a case that a symbol in resources allocated for the PUSCH transmission in the UL subband includes reserved resources configured by an activated rate match pattern(s) applicable for the PUSCH transmission:
determine a frequency domain region out of the reserved resources in the symbol that includes a maximum number of consecutive resource units is available for the PUSCH transmission; or
determine that the symbol is not available for the PUSCH transmission.

7. The UE of claim 1, wherein the at least one processor is further configured to cause the UE to:
receive configurations of one or more rate match pattern groups for physical downlink shared channel (PDSCH) transmission; and
determine that a rate match pattern group in the one or more rate match pattern groups is applicable for the PUSCH transmission in a case that reserved resources configured by a rate match pattern in the rate match pattern group are fully or partly within resources allocated for the PUSCH transmission in the UL subband.

8. The UE of claim 7, wherein the at least one processor is further configured to cause the UE to receive downlink control information (DCI) scheduling the PUSCH transmission, wherein the DCI indicates whether a rate match pattern group applicable for the PUSCH transmission is activated or deactivated.

9. The UE of claim 1, wherein the one or more rate match patterns are configured for the PUSCH transmission.

10. The UE of claim 9, wherein a configuration of a rate match pattern includes at least one bitmap indicating reserved resources, and the at least one bitmap is configured based at least in part on at least one of:
a configuration for the UL subband; or
a slot including the UL subband.

11. The UE of claim 9, wherein a configuration of a rate match pattern includes an identity (ID) of a control resource set (CORESET) including reserved resources and an ID of a bandwidth part (BWP) associated with the CORESET.

12. The UE of claim 9, wherein a rate match pattern for PUSCH transmission is associated with a corresponding rate match pattern for a physical downlink shared channel (PDSCH) transmission, and a rate match pattern of the one or more rate match patterns includes reserved resources configured by the corresponding rate match pattern for the PDSCH transmission and is within the UL subband.

13. The UE of claim 9, wherein to determine whether physical resources in the UL subband are available or not for the PUSCH transmission, the at least one processor is configured to cause the UE to, in a case that a symbol in resources allocated for the PUSCH transmission in the UL subband includes reserved resources configured by an activated rate match pattern(s) in the one or more rate match patterns:
determine a frequency domain region out of the reserved resources in the symbol that includes a maximum number of consecutive resource units is available for the PUSCH transmission; or
determine that the symbol is not available for the PUSCH transmission.

14. A base station (BS) for wireless communication, comprising:
at least one memory; and
at least one processor coupled with the at least one memory and configured to cause the BS to:
transmit configurations of one or more rate match patterns; and
determine whether physical resources in an uplink (UL) subband are available or not for a physical uplink shared channel (PUSCH) transmission based at least in part on the one or more rate match patterns.

15. A method performed by a user equipment (UE), the method comprising:
receiving configurations of one or more rate match patterns; and
determining whether physical resources in an uplink (UL) subband are available or not for a physical uplink shared channel (PUSCH) transmission based at least in part on the one or more rate match patterns.

16. A processor for wireless communication, comprising:
at least one controller coupled with at least one memory and configured to cause the processor to:
receive configurations of one or more rate match patterns; and
determine whether physical resources in an uplink (UL) subband are available or not for a physical uplink shared channel (PUSCH) transmission based at least in part on the one or more rate match patterns.

17. The processor of claim 16, wherein the one or more rate match patterns are configured for a physical downlink shared channel (PDSCH) transmission, and wherein to determine whether physical resources in the UL subband are available or not for the PUSCH transmission, the at least one controller is configured to cause the processor to:
in a case that resources allocated for the PUSCH transmission in the UL subband include reserved resources configured by a rate match pattern in the one or more rate match patterns, determine that a whole symbol(s) including the reserved resources in the resources allocated for the PUSCH transmission is not available for the PUSCH transmission.

18. The processor of claim 16, wherein the one or more rate match patterns are configured for a physical downlink shared channel (PDSCH) transmission, and wherein to determine whether physical resources in the UL subband are available or not for the PUSCH transmission, the at least one controller is configured to cause the processor to:
in a case that resources allocated for the PUSCH transmission in the UL subband include reserved resources configured by a rate match pattern in the one or more rate match patterns and the rate match pattern is within a rate match pattern group, determine that the reserved resources are available for the PUSCH transmission.

19. The processor of claim 16, wherein the one or more rate match patterns are configured for a physical downlink shared channel (PDSCH) transmission, and the processor is further configured to determine at least one rate match pattern applicable for the PUSCH transmission based at least in part on the one or more rate match patterns.

20. The processor of claim 16, wherein the at least one controller is further configured to cause the processor to:
receive configurations of one or more rate match pattern groups for physical downlink shared channel (PDSCH) transmission; and
determine that a rate match pattern group in the one or more rate match pattern groups is applicable for the PUSCH transmission in a case that reserved resources configured by a rate match pattern in the rate match pattern group are fully or partly within resources allocated for the PUSCH transmission in the UL subband.
